(19) United States
(12) Patent Application Publication
(10) Pub. No.: US 2024/0427699 A1
(43) Pub. Date: Dec. 26, 2024

(54) REFERENCING MEMORY USING PORTIONS OF A SPLIT LOGICAL BLOCK ADDRESS

(71) Applicant: Micron Technology, Inc., Boise, ID (US)

(72) Inventors: Mattia Robustelli, Milano (IT); Innocenzo Tortorelli, Naviglio (IT); Alessandro Novati, Verano Brianza (IT); Nicola Colella, Capodrise (IT); Antonino Pollio, Vico Equense (IT)

(21) Appl. No.: 18/747,037

(22) Filed: Jun. 18, 2024

Related U.S. Application Data
(60) Provisional application No. 63/510,021, filed on Jun. 23, 2023.

(51) Int. Cl. G06F 12/02; G06F 13/16

(52) U.S. Cl. CPC G06F 12/0292; G06F 12/0246; G06F 13/1668; G06F 2212/7201

(57) ABSTRACT

The subject application related to referencing memory using portions of a split logical block address. A method includes receiving a memory operation including a logical block address (LBA). The method also includes splitting the LBA into a first portion and a second portion. The method further includes determining a physical block of a memory using a logical-to-physical (L2P) table to map the first portion of the LBA to the physical block. The physical block includes a plurality of physical block addresses (PBAs). The method further includes combining the second portion of the LBA and the physical block to reference a physical block address (PBA) of the physical block. The method further includes performing the memory operation at the PBA of the physical block.

### CROSS-REFERENCE TO RELATED APPLICATION

The present application claims the benefit of U.S. Provisional Patent Application No. 63/510,021 filed on Jun. 23, 2023, which is incorporated by reference herein in its entirety.

### TECHNICAL FIELD

The present disclosure generally relates to referencing memory, and more specifically, relates to splitting a logical block address into portions and referencing memory using the portions of the logical block address.

### BACKGROUND ART

A memory subsystem can include one or more memory devices that store data. The memory devices can be, for example, non-volatile memory devices and volatile memory devices. In general, a host system can utilize a memory subsystem to store data at the memory devices and to retrieve data from the memory devices.

### SUMMARY OF THE INVENTION

In one aspect, the present disclosure provides a method comprising: receiving a memory operation including a logical block address (LBA); splitting the LBA into a first portion and a second portion; determining a physical block of a memory using a logical-to-physical (L2P) table to map the first portion of the LBA to the physical block, wherein the physical block includes a plurality of physical block addresses (PBAs); combining the second portion of the LBA and the physical block to reference a physical block address (PBA) of the physical block; and performing the memory operation at the PBA of the physical block.

In another aspect, the present disclosure provides a non-transitory computer-readable storage medium comprising instructions that, when executed by a processing device, cause the processing device to: receive a memory operation including a logical block address (LBA); split the LBA into a first portion and a second portion; determine a physical block of a memory using a logical-to-physical (L2P) table to map the first portion of the LBA to the physical block, wherein the physical block includes a plurality of physical block addresses (PBAs); combine the second portion of the LBA and the physical block to reference a physical block address (PBA) of the physical block; and perform the memory operation at the PBA of the physical block.

In another aspect, the present disclosure provides a system comprising: a plurality of memory devices; and a processing device, operatively coupled with the plurality of memory devices, to: receive a memory operation including a logical block address (LBA); split the LBA into a first portion and a second portion, wherein the first portion of the LBA includes one or more most significant bits of the LBA; determine a physical block of a memory using a logical-to-physical (L2P) table to map the first portion of the LBA to the physical block, wherein the physical block includes a plurality of physical block addresses (PBAs); combine the second portion of the LBA and the physical block to reference a physical block address (PBA) of the physical block; and perform the memory operation at the PBA of the physical block.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a memory subsystem in accordance with some embodiments of the present disclosure.

FIG. 2 is a flow diagram of an example method of referencing memory using portions of a split logical block address, in accordance with some embodiments of the present disclosure.

FIG. 3 is another flow diagram of referencing memory using portions of a split logical block address, in accordance with some embodiments of the present disclosure.

FIG. 4 is a block diagram of an example computer system in which embodiments of the present disclosure may operate.

### DETAILED DESCRIPTION

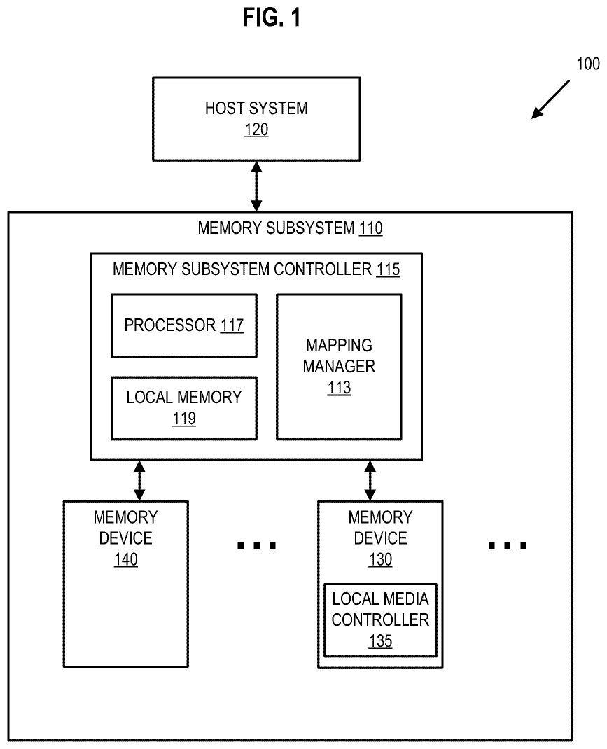

Aspects of the present disclosure are directed to referencing memory using portions of a split logical block address. A memory subsystem can be a storage device, a memory module, or a hybrid of a storage device and memory module. Examples of storage devices and memory modules are described below in conjunction with FIG. 1. In general, a host system can utilize a memory subsystem that includes one or more components, such as memory devices that store data. The host system can provide data to be stored at the memory subsystem and can request data to be retrieved from the memory subsystem.

A memory device can be a non-volatile memory device. A non-volatile memory device is a package of one or more dice. One example of non-volatile memory devices is a negative-and (NAND) memory device. Other examples of non-volatile memory devices are described below in conjunction with FIG. 1. The dice in the packages can be assigned to one or more channels for communicating with a memory subsystem controller. Each die can consist of one or more planes. Planes can be grouped into logic units (LUN). For some types of non-volatile memory devices (e.g., NAND memory devices), each plane consists of a set of physical blocks, which are groups of memory cells to store data. A cell is an electronic circuit that stores information.

Depending on the cell type, a cell can store one or more bits of binary information, and has various logic states that correlate to the number of bits being stored. The logic states can be represented by binary values, such as “0” and “1”, or combinations of such values. There are various types of cells, such as single-level cells (SLCs), multi-level cells (MLCs), triple-level cells (TLCs), and quad-level cells (QLCs). For example, an SLC can store one bit of information and has two logic states.

Memory subsystems often use a combination of logical addresses (e.g., logical block addresses “LBAs”) and physical addresses (e.g., physical block addresses “PBAs”) for performing memory operations (e.g., read and write operations). In particular, LBAs are used by host systems for generating memory requests (e.g., read and write requests), whereas PBAs are used by the memory subsystem to identify memory elements in a set of memory components to fulfill the memory requests. This description refers to LBAs and PBAs for case of reference, but other logical and physical addresses can be used. Additionally, while both refer to “blocks,” physical blocks and logical blocks can refer to different portions of memory. For one example, a physical block can store multiple logical blocks.

To facilitate these multiple address spaces, the memory subsystem maintains a logical-to-physical (L2P) table that maps LBAs to PBAs. For example, for memory subsystems that perform write out-of-place operations, the memory subsystem locates a free memory element in an associated set of memory components to write data associated with the write request to the free memory element. Thereafter, the memory subsystem records a LBA obtained in the write request and a PBA of the memory element that was written to in an entry of the L2P table. Processes such as garbage collection, error correction, and wear leveling can cause a memory subsystem to move data from one physical location to another. By updating the L2P table, the memory subsystem can execute these processes without altering the logical addressing used by a host system.

Generally, the mapping of the LBA to the PBA in the L2P table occurs at the logical block address level. For example, 4 KB logical block addresses are mapped to 4 KB physical block addresses. Because conventional memory subsystems perform out of place write operations that involve writing to a new PBA for each write command (including write commands resulting from internal processes that move data), conventional memory subsystems update the L2P table for each write command.

While recording logical-to-physical mappings at the LBA level allows the memory subsystem to manage the memory components at a granular level, such flexibility comes at a cost of size. With growing non-volatile storage sizes and limited volatile memory resources, memory subsystems cannot load the entire L2P table into main memory during normal operation. Instead, the memory subsystem maintains the entire L2P table in a high-latency but abundant non-volatile memory and loads only a subset of the entries/mappings from the L2P table into a lower-latency but more limited volatile main memory. In this configuration, the memory subsystem swaps relevant entries/mappings of the L2P table from the non-volatile memory into the partial L2P table in volatile media as needed. The process of moving and maintaining portions of the L2P table between different media adds considerable overhead, including latency, to fulfillment of memory operations. This overhead can outweigh the benefit of fine granularity in addressing. This is especially true when such an addressing scheme is used in a write-in-place memory because a write-in-place memory reduces the need to move data (e.g., processes can overwrite data in an existing physical location rather than writing the data to a new physical location).

Aspects of the present disclosure address the above and other deficiencies by loading a less granular L2P table in volatile memory. The L2P table maps a range of LBAs to a physical block of non-volatile memory. Mapping ranges of LBAs to physical blocks of non-volatile memory reduces the size of the L2P table without requiring a change in logical block addressing. A mapping manager divides the received LBA into first and second portions or subsets. The mapping manager maps the first portion or subset of the LBA to a physical block of non-volatile memory using the L2P table. The second portion or subset of the LBA indicates an offset within the physical block. The mapping manager combines the second portion/subset of the LBA with the determined physical block to reference a physical block address (PBA) (e.g., offset within the physical block). This less granular L2P table can be made small enough to be cached entirely in volatile memory or at least reduce the amount of swapping of L2P table entries between volatile and non-volatile memory, thereby reducing conventional address management overhead.

FIG. 1 illustrates an example computing system 100 that includes a memory subsystem 110 in accordance with some embodiments of the present disclosure. The memory subsystem 110 can include media, such as one or more volatile memory devices (e.g., memory device 140), one or more non-volatile memory devices (e.g., memory device 130), or a combination of such.

A memory subsystem 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory subsystems 110. In some embodiments, the host system 120 is coupled to different types of memory subsystems 110. FIG. 1 illustrates one example of a host system 120 coupled to one memory subsystem 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 120 uses the memory subsystem 110, for example, to write data to the memory subsystem 110 and read data from the memory subsystem 110.

The host system 120 can be coupled to the memory subsystem 110 via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), Small Computer System Interface (SCSI), a double data rate (DDR) memory bus, a dual in-line memory module (DIMM) interface (e.g., DIMM socket interface that supports Double Data Rate (DDR)), Open NAND Flash Interface (ONFI), Double Data Rate (DDR), Low Power Double Data Rate (LPDDR), or any other interface. The physical host interface can be used to transmit data between the host system 120 and the memory subsystem 110. The host system 120 can further utilize an NVM Express (NVMe) interface to access components (e.g., memory devices 130) when the memory subsystem 110 is coupled with the host system 120 by the PCIe interface. The physical host interface can provide an interface for passing control, address, data, and other signals between the memory subsystem 110 and the host system 120. FIG. 1 illustrates a memory subsystem 110 as an example. In general, the host system 120 can access multiple memory subsystems via a same communication connection, multiple separate communication connections, and/or a combination of communication connections.

The memory devices 130,140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include negative-and (NAND) type flash memory and write-in-place memory, such as a three-dimensional cross-point (“3D cross-point”) memory device, which is a cross-point array of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Although non-volatile memory devices such as NAND type memory (e.g., 2D NAND, 3D NAND) and 3D cross-point array of non-volatile memory cells are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

A memory subsystem controller 115 (or controller 115 for simplicity) can communicate with the memory devices 130 to perform operations such as reading data, writing data, or erasing data at the memory devices 130 and other such operations (e.g., in response to commands scheduled on a command bus by controller 115). The memory subsystem controller 115 can include hardware such as one or more integrated circuits and/or discrete components, a buffer memory, or a combination thereof. The hardware can include digital circuitry with dedicated (i.e., hard-coded) logic to perform the operations described herein. The memory subsystem controller 115 can be a microcontroller, special purpose logic circuitry (e.g., a field programmable gate array (FPGA), an application specific integrated circuit (ASIC), etc.), or another suitable processor.

The memory subsystem controller 115 can include a processing device 117 (processor) configured to execute instructions stored in a local memory 119. In the illustrated example, the local memory 119 of the memory subsystem controller 115 includes an embedded memory configured to store instructions for performing various processes, operations, logic flows, and routines that control operation of the memory subsystem 110, including handling communications between the memory subsystem 110 and the host system 120.

In some embodiments, the local memory 119 can include memory registers storing memory pointers, fetched data, etc. The local memory 119 can also include read-only memory (ROM) for storing micro-code. While the example memory subsystem 110 in FIG. 1 has been illustrated as including the memory subsystem controller 115, in another embodiment of the present disclosure, a memory subsystem 110 does not include a memory subsystem controller 115, and can instead rely upon external control (e.g., provided by an external host, or by a processor or controller separate from the memory subsystem 110).

In general, the memory subsystem controller 115 can receive commands or operations from the host system 120 and can convert the commands or operations into instructions or appropriate commands to achieve the desired access to the memory devices 130 and/or the memory device 140. The memory subsystem controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory devices 130. The memory subsystem controller 115 can further include host interface circuitry to communicate with the host system 120 via the physical host interface. The host interface circuitry can convert the commands received from the host system into command instructions to access the memory devices 130 and/or the memory device 140 as well as convert responses associated with the memory devices 130 and/or the memory device 140 into information for the host system 120.

The memory subsystem 110 can also include additional circuitry or components that are not illustrated. In some embodiments, the memory subsystem 110 can include a cache or buffer (e.g., DRAM) and address circuitry (e.g., a row decoder and a column decoder) that can receive an address from the memory subsystem controller 115 and decode the address to access the memory devices 130.

In some embodiments, the memory devices 130 include local media controllers 135 that operate in conjunction with memory subsystem controller 115 to execute operations on one or more memory cells of the memory devices 130. An external controller (e.g., memory subsystem controller 115) can externally manage the memory device 130 (e.g., perform media management operations on the memory device 130). In some embodiments, a memory device 130 is a managed memory device, which is a raw memory device combined with a local controller (e.g., local controller 135) for media management within the same memory device package. An example of a managed memory device is a managed NAND (MNAND) device.

The memory subsystem 110 includes a mapping manager 113 that can split a LBA into portions and use each of the portions of the LBA to reference memory. The mapping manager 113 can map a first portion of a received LBA to a physical block mapped to a range of LBAs. The mapping manager 113 uses a second portion of the received LBA as an offset referencing a PBA of the physical block. In some embodiments, the controller 115 includes at least a portion of the mapping manager 113. For example, the controller 115 can include a processor 117 (processing device) configured to execute instructions stored in local memory 119 for performing the operations described herein. In some embodiments, a mapping manager 113 is part of the host system 120, an application, or an operating system.

The mapping manager 113 can manage a complete L2P table in volatile memory. The mapping manager 113 only updates the L2P table in volatile memory responsive to maintenance operations acting on physical blocks of the non-volatile memory. As a result, the mapping manager 113 does not need to query non-volatile memory for entries/mappings of a L2P table. The limited management of the complete L2P table in volatile memory reduces latency conventionally involved with fulfilling memory operations. Further details with regard to the operations of the mapping manager 113 are described below.

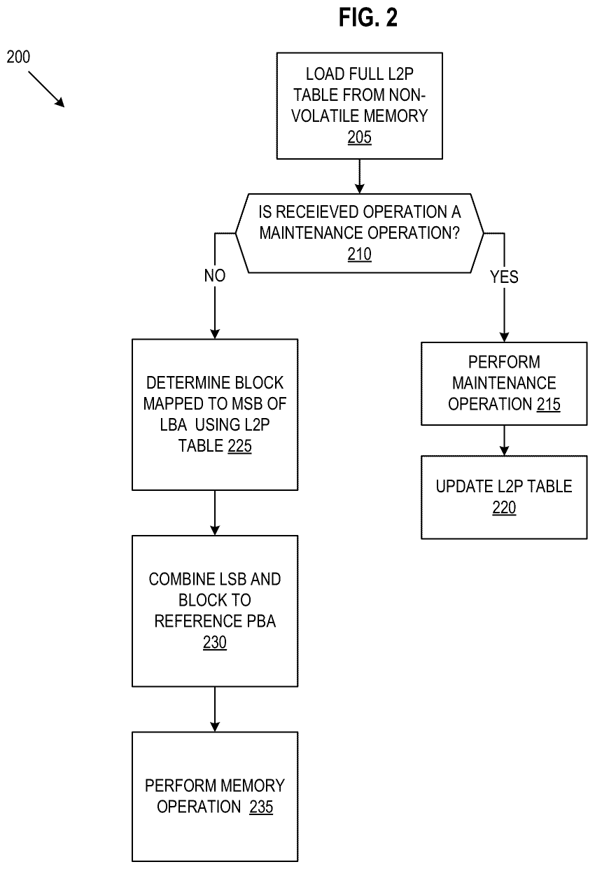

FIG. 2 is a flow diagram of an example method of referencing memory using portions of a split logical block address, in accordance with some embodiments of the present disclosure. It should be appreciated that while a single L2P table is described, a processing device (such as mapping manager 113) may manage multiple L2P tables cached in volatile memory.

The method 200 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 200 is performed by the mapping manager 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 205, the processing device loads a full/complete copy of the L2P table as stored in non-volatile memory into volatile memory. Unlike conventional systems that map LBAs to PBAs and can only cache a subset of the full L2P table in volatile memory, because the L2P table maps a range of LBAs to physical blocks of non-volatile memory, the entirety of the less-granular L2P table can be cached into volatile memory. In some implementations, the mapping manager 113 loads the L2P table during bootup. In some embodiments, the mapping manager 113 loads a portion of the L2P table, but the less-granular L2P table allows the mapping manager 113 to reduce L2P entry swaps, flushes, and other overhead.

At operation 210, the processing device determines whether a received operation is a maintenance operation. The received operation can be a read operation indicating one or more LBAs directing the mapping manager 113 to one or more locations/addresses of non-volatile memory that contain the data to be read. The received operation can also be a write operation identifying data to be written to one or more LBAs. The received operation may be an internal operation (e.g., originating from memory subsystem 110) or an external operation (e.g., originating from host system 120).

In some embodiments, the mapping manager 113 compares the received operation to a predetermined list of maintenance operations. Maintenance operations include read/write operations associated with internal management of the memory subsystem 110 including garbage collection, wear leveling, and the like. Additionally or alternatively, the mapping manager 113 determines that any operation received from a host system 120 is not a maintenance operation. If a received operation is a maintenance operation, the flow of operations moves to operation 215. If the received operation is not a maintenance operation, the flow of operations moves to operation 225.

At operation 215, the processing device performs the maintenance operation. For example, to perform a wear leveling operation, the mapping manager 113 moves data written to one or more first PBAs stored at a first physical block to one or more second PBAs stored at a second physical block of the non-volatile memory. In some implementations, the mapping manager 113 performs a number of read/write operations equal to the number of PBAs of a physical block to move each of the PBAs of the physical block to PBAs of the second physical block. In other implementations, the mapping manager 113 recognizes a single dedicated operation configured to move data of each of the PBAs of the physical block to PBAs of another physical block. In this manner, instead of performing multiple read/write operations, a single dedicated command reads data at PBAs of the first physical block and subsequently writes data to PBAs of the second physical block.

At operation 220, the processing device updates the L2P table in volatile memory. As described herein, the L2P table cached in volatile memory maps each range of LBAs to a respective physical block (e.g., a first range of LBAs to a first physical block, a second range of LBAs to a second physical block, etc.). In some embodiments, each entry of the L2P table maps a range of LBAs to a single physical block using a common value in a portion of the LBAs. For example, each LBA in the range of LBAs shares the same value in the most significant bits (MSB). Accordingly, when the mapping manager 113 changes a physical block associated with a range of LBAs (as is commonly performed during maintenance operations), the mapping manager 113 updates the L2P table in volatile memory. For example, the mapping manager 113 remaps the common MSB value mapped to the previous physical block to a new physical block. The mapping manager 113 synchronizes the L2P table in volatile memory by flushing the new mapping(s) for the one or more physical blocks of the L2P table affected by the maintenance operation to the L2P table stored in nonvolatile memory. Given the L2P table is less granular than a conventional L2P table, the granularity of the synchronization is at a physical block level.

At operation 225, the processing device determines a physical block mapped to the LBA. For example, the mapping manager 113 splits the LBA into multiple portions. Portions of the LBA can include one or more most significant bits, one or more least significant bits (LSB), or some other partial combination of bits of the LBA. In a non-limiting example, a first portion of the LBA includes one or more MSB of the LBA and a second portion of the LBA includes one or more LSB of the LBA. The mapping manager 113 uses a value read or otherwise determined from the MSB to lookup a mapping to a physical block in the L2P table, where a range of LBAs sharing a common MSB value map to a single physical block of memory. For example, the mapping manager 113 uses the first portion/MSB of the split LBA (i.e., excluding the second portion/LSB of the split LBA) to lookup a mapping between the value of the first portion and the physical block.

At operation 230, the processing device combines the second portion/LSB of the LBA and the physical block to reference a PBA of the physical block. The physical block of the non-volatile memory includes a range of PBAs. Each PBA is at a location in each physical block defined by an offset. For example, the 12th PBA is located at an offset of 12 in a physical block. In a non-limiting example, the mapping manager 113 uses one or more LSBs of the LBA to reference the offset/PBA. In one embodiment, the second portion/LSB of the LBA remains unchanged, other than the split, from receipt when combined with the physical block. For example, the mapping manager 113 does not use a table, scrambling, or other algorithm or translation to map the second portion/LSB to a different value.

In one embodiment, the mapping manager 113 determines which bits of the LBA to use as an offset based on a number of PBAs of each physical block. The larger the range of the PBAs of the physical block, the more bits of the LBA used to reference a PBA of the physical block. In contrast, the smaller the range of PBAs of the physical block, the fewer bits of the LBA used to reference a PBA of the physical block.

In a non-limiting example, each physical block of non-volatile memory maps 64 LBAs to 64 PBAs. An entry of the L2P table maps MSB values to physical blocks. The mapping manager 113 splits an LBA using the MSB count and the LSB count. As described herein, the number of bits of MSB and/or LSB depends on a number of physical blocks and a number of PBAs of each physical block. In this example, 6 bits are needed to address each of the 64 addresses of the physical block because the physical block includes 64 PBAs. Accordingly, the mapping manager 113 maps at least the six least significant bits of the LBA to identify an offset that identifies a location of the PBA within the physical block. The mapping manager 113 uses the remaining bits (i.e., MSB) to lookup the physical block in the L2P table.

At operation 235, the processing device performs the memory operation (e.g., a read/write request that is not involved in a maintenance operation). If the memory operation is a read request, then the read request is performed at a location of the offset of the physical block (i.e., the PBA). In one embodiment, the read operation is performed in byte addressable non-volatile memory. In general, a read operation involves applying a voltage to a word line powering a transistor (e.g., a memory cell of the memory subsystem). If the memory operation is a write request, then the write operation is performed at a location of the offset of the physical block. As described herein, write in-place operations are not dependent on the availability of a PBA. Accordingly, the mapping manager 113 may perform a write operation to overwrite data at a PBA. Because the L2P described herein does not map LBAs to PBAs (and instead maps LBAs to physical blocks of non-volatile memory), the mapping manager 113 does not need to update the L2P table cached in volatile memory responsive to a write in-place operation. In some embodiments, the mapping manager 113 updates the L2P table stored in non-volatile memory when the memory subsystem 110 is powering down, during an idle mode, or during any other period of time that will not affect the performance of the memory subsystem 110.

In a non-limiting example, 256 physical blocks each map 64 LBAs to 64 PBAs. In the example, the mapping manager 113 receives a read request addressing a range of LBAs, where each LBA in the range represents a 14-bit address. The mapping manager 113 splits each 14-bit LBA into a first portion and a second portion, where the first portion includes the 8 MSB values that reference a physical block of the 256 physical blocks, and the second portion includes the 6 LSB values that reference an offset of the 64 PBAs of the physical block. The mapping manager 113 uses the L2P table described herein to match the MSB values to a physical block. The mapping manager 113 then uses the LSB values as an offset value from the start of the physical block. Subsequently, the mapping manager 113 performs the read operation at the PBA.

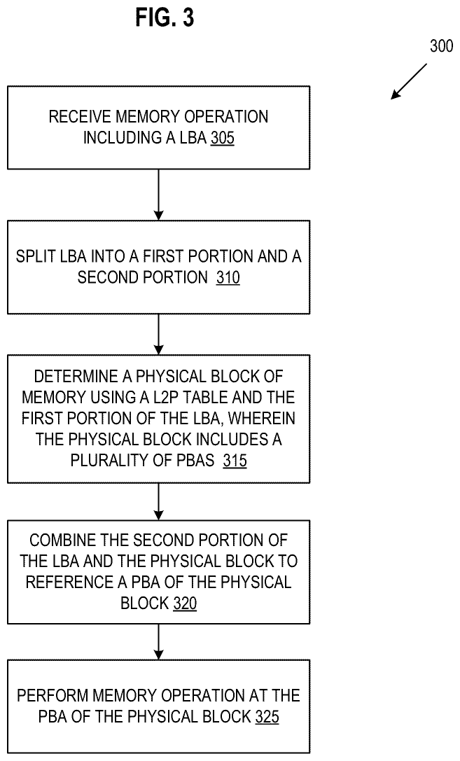

FIG. 3 is a flow diagram of an example method 300 of referencing memory using portions of a split logical block address in accordance with some embodiments of the present disclosure. The method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300 is performed by the mapping manager 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 305, the processing device receives a memory operation. The memory operation can be a read request or a write request. If the memory operation is a read request, the read request may indicate one or more LBAs directing the processing device to one or more locations/addresses of memory that contain the data to be read. If the memory operation is a write request, the write request may identify data to be written to one or more LBAs.

At operation 310, the processing device splits the LBA into a first portion and a second portion. As described with reference to operation 225, the mapping manager 113 splits the LBA into multiple portions, where portions of the LBA can include one or more most significant bits, one or more least significant bits, or some other partial combination of bits of the LBA. In one embodiment, the first portion includes one or more MSB of the LBA, and the second portion includes one or more LSB of the LBA.

At operation 315, the processing device determines a physical block of the memory using a L2P table and the first portion of the LBA. As described with reference to operation 225, the mapping manager 113 maps a value determined from the MSB to a physical block using the L2P table where a range of LBAs sharing a common MSB value map to a single physical block of memory.

At operation 320, the processing device combines the second portion of the LBA and the physical block to reference a PBA of the physical block. As described with reference to operation 230, the mapping manager uses one or more bits of the LSB as the second portion of the LBA. The one or more bits of the LSB indicate an offset of a physical block to reference a PBA of the physical block.

At operation 325, the processing device performs the memory operation at the PBA of the physical block. With reference to operation 235, the mapping manager performs a read request or a write request at a PBA referenced using the offset of the physical block.

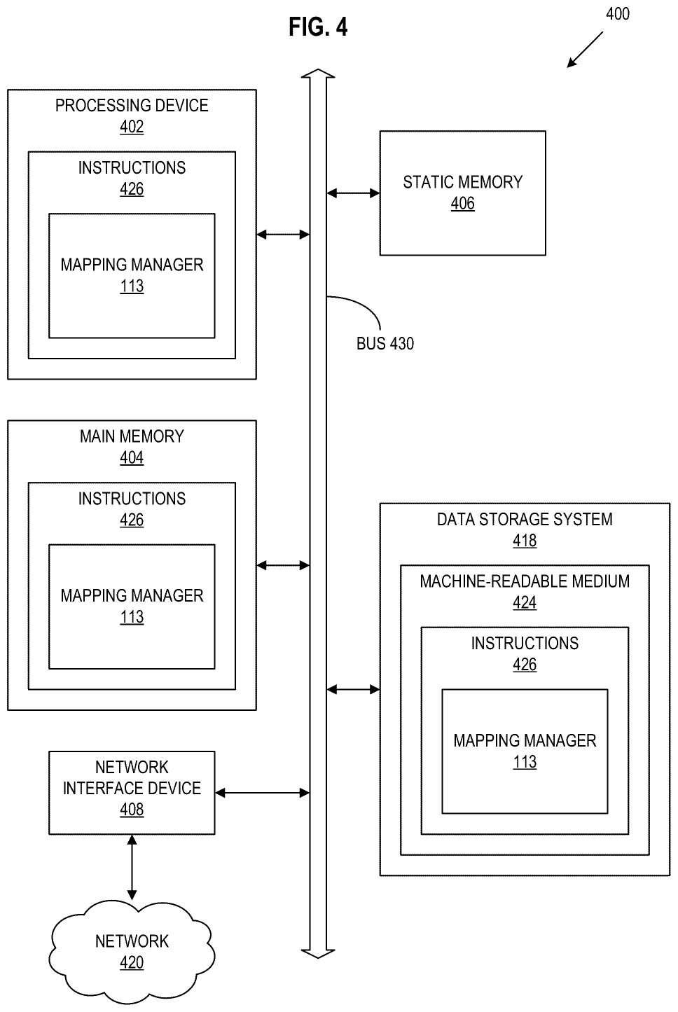

FIG. 4 illustrates an example machine of a computer system 400 within which a set of instructions, for causing the machine to perform any one or more of the methodologies discussed herein, can be executed. In some embodiments, the computer system 400 can correspond to a host system (e.g., the host system 120 of FIG. 1) that includes, is coupled to, or utilizes a memory subsystem (e.g., the memory subsystem 110 of FIG. 1) or can be used to perform the operations of a controller (e.g., to execute an operating system to perform operations corresponding to the mapping manager 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 400 includes a processing device 402, a main memory 404 (e.g., read-only memory (ROM), flash memory, dynamic random access memory (DRAM) such as synchronous DRAM (SDRAM) or Rambus DRAM (RDRAM), etc.), a static memory 406 (e.g., flash memory, static random access memory (SRAM), etc.), and a data storage system 418, which communicate with each other via a bus 430.

Processing device 402 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 402 can also be one or more special-purpose processing devices such as an application specific integrated circuit (ASIC), a field programmable gate array (FPGA), a digital signal processor (DSP), network processor, or the like. The processing device 402 is configured to execute instructions 426 for performing the operations and steps discussed herein. The computer system 400 can further include a network interface device 408 to communicate over the network 420.

The data storage system 418 can include a machine-readable storage medium 424 (also known as a computer-readable medium) on which is stored one or more sets of instructions 426 or software embodying any one or more of the methodologies or functions described herein. The instructions 426 can also reside, completely or at least partially, within the main memory 404 and/or within the processing device 402 during execution thereof by the computer system 400, the main memory 404 and the processing device 402 also constituting machine-readable storage media. The machine-readable storage medium 424, data storage system 418, and/or main memory 404 can correspond to the memory subsystem 110 of FIG. 1.

In one embodiment, the instructions 426 include instructions to implement functionality corresponding to a mapping manager (e.g., the mapping manager 113 of FIG. 1). While the machine-readable storage medium 424 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system, such as the mapping manager 113 may carry out the computer-implemented methods 200 and/or 300 in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method comprising:
receiving a memory operation including a logical block address (LBA);
splitting the LBA into a first portion and a second portion;
determining a physical block of a memory using a logical-to-physical (L2P) table to map the first portion of the LBA to the physical block, wherein the physical block includes a plurality of physical block addresses (PBAs);
combining the second portion of the LBA and the physical block to reference a physical block address (PBA) of the physical block; and
performing the memory operation at the PBA of the physical block.

2. The method of claim 1, wherein the first portion of the LBA includes one or more most significant bits of the LBA.

3. The method of claim 1, wherein the second portion of the LBA includes one or more least significant bits.

4. The method of claim 1, wherein performing the memory operation at the PBA of the physical block further comprises:
performing a write in-place operation to write data at the PBA.

5. The method of claim 1, further comprising:
moving data written to the plurality of PBAs of the physical block to a second plurality of PBAs of a second physical block using a single command.

6. The method of claim 5, further comprising:
updating the L2P table by remapping a set of one or more most significant bits of the LBA to the second physical block.

7. The method of claim 1, further comprising:
loading the L2P table to a cache in volatile memory, wherein the loaded L2P table is a complete copy of the L2P table as stored in non-volatile memory.

8. A non-transitory computer-readable storage medium comprising instructions that, when executed by a processing device, cause the processing device to:
receive a memory operation including a logical block address (LBA);
split the LBA into a first portion and a second portion;
determine a physical block of a memory using a logical-to-physical (L2P) table to map the first portion of the LBA to the physical block, wherein the physical block includes a plurality of physical block addresses (PBAs);
combine the second portion of the LBA and the physical block to reference a physical block address (PBA) of the physical block; and
perform the memory operation at the PBA of the physical block.

9. The non-transitory computer-readable storage medium of claim 8, wherein the first portion of the LBA includes one or more most significant bits of the LBA.

10. The non-transitory computer-readable storage medium of claim 8, wherein the second portion of the LBA includes one or more least significant bits.

11. The non-transitory computer-readable storage medium of claim 8, wherein performing the memory operation at the PBA of the physical block further causes the processing device to:
perform a write in-place operation to write data at the PBA.

12. The non-transitory computer-readable storage medium of claim 8, wherein the processing device is further to:
move data written to the plurality of PBAs of the physical block to a second plurality of PBAs of a second physical block using a single command.

13. The non-transitory computer-readable storage medium of claim 12, wherein the processing device is further to:
update the L2P table by remapping a set of one or more most significant bit of the LBA to the second physical block.

14. The non-transitory computer-readable storage medium of claim 8, wherein the processing device is further to:
load the L2P table to a cache in volatile memory, wherein the loaded L2P table is a complete copy of the L2P table as stored in non-volatile memory.

15. A system comprising:
a plurality of memory devices; and
a processing device, operatively coupled with the plurality of memory devices, to:
receive a memory operation including a logical block address (LBA);
split the LBA into a first portion and a second portion, wherein the first portion of the LBA includes one or more most significant bits of the LBA;
determine a physical block of a memory using a logical-to-physical (L2P) table to map the first portion of the LBA to the physical block, wherein the physical block includes a plurality of physical block addresses (PBAs);
combine the second portion of the LBA and the physical block to reference a physical block address (PBA) of the physical block; and
perform the memory operation at the PBA of the physical block.

16. The system of claim 15, wherein the second portion of the LBA includes one or more least significant bits.

17. The system of claim 15, wherein performing the memory operation at the PBA of the physical block is further to:
perform a write in-place operation to write data at the PBA.

18. The system of claim 15, wherein the processing device is further to:
move data written to the plurality of PBAs of the physical block to a second plurality of PBAs of a second physical block using a single command.

19. The system of claim 18, wherein the processing device is further to:
update the L2P table by remapping a set of one or more most significant bits of the LBA to the second physical block.

20. The system of claim 15, wherein the processing device is further to:
load the L2P table to a cache in volatile memory, wherein the loaded L2P table is a complete copy of the L2P table as stored in non-volatile memory.
